(19) United States
(12) Patent Application Publication
(10) Pub. No.: US 2003/0058169 A1
(43) Pub. Date: Mar. 27, 2003

(54) Broad band communications antenna

(76) Inventor: Wolfgang Heyde, Herisau (CH)

Correspondence Address: William H Lodgson, 700 Koppers Building, 436 Seventh Avenue, Pittsburgh, PA, 15219-1818, US

(21) Appl. No.: 10/240,475

(22) PCT Filed: Mar. 30, 2001
(86) PCT No.: PCT/CH01/00199

(30) Foreign Application Priority Data
Apr. 4, 2000 (CH) 663/00

(51) Int. Cl. H01Q 1/42

(52) U.S. Cl. 343/700 MS; 343/789

(57) ABSTRACT

The invention relates to a broad band communications antenna that is provided with a base plate which is provided with a conductive layer (14) that is provided with at least one coupler opening. A strip line network (15) is provided at a little distance from the conductive layer (14) in the region of the coupler openings. At least one conductive patch (16, 17) is arranged opposite the base plate (13). The base plate (13) and the patch (16, 17) are arranged in a conductive housing (2) which is provided with an open side (19). The base plate is arranged closest to the bottom (3) of the housing and therefore farthest from the open side (19). One or more link/s (5) is/are provided on the open side (19) of the housing (2). Said links reduce/s the open cross-sectional surface of the housing (2) when the open side (19) is seen from above.

The invention relates to a broadband communications antenna having a baseplate which has a conductive layer having at least one coupling opening, with a stripline network being provided at a short distance from the conductive layer in the region of the coupling openings, with at least one conductive patch being arranged opposite the baseplate, with the baseplate and the patch being arranged in a conductive housing which has one open side, and with the baseplate being arranged closest to the housing bottom and thus furthest away from the open side.

A broadband antenna such as this is known from a report on the Ecole Polytechnique Fédérale de Lausanne, which was published under the title “SSAIP: A Cavity Backed Alternative to Broadband Communication Antennas”.

Microstrip antennas are known per se, and are in widespread use. Their field of operation is restricted by their narrow bandwidth, which is a result of their resonant structure. The use of thick substrates and a number of layers to increase the bandwidth leads to a reduction in the radiation efficiency of the antennas. The prior art mentioned above proposes an antenna which has a physical height of 30 millimeters for a frequency of approximately 6 Gigahertz.

A new mobile radio standard entitled UMTS (Universal Mobile Telecommunications System) has been defined with frequencies in the band between 1920 and 2170 Megahertz. The existing GSM 1800 network is located in the frequency band between 1710 and 1880 Megahertz. It would now be desirable to specify a broadband antenna which can cover both frequency bands. The prior art is not suitable for this purpose, either in terms of its respective power levels for the two bands or in terms of its technical design, since the antenna has a physical height of more than 70 mm in this frequency band. The prior art provides a bandwidth of approximately 25% for matching with 10 dB, while in contrast a band width of more than 30% would be desirable.

Against the background of this prior art, the invention is based on the object of improving an antenna of the type mentioned initially such that this antenna allows integration of a GSM network and the UMTS network by means of a single antenna, with losses that are as low as possible.

This object is achieved in that one or more lugs are provided on the open side of the housing and reduce the size of the open cross-sectional area of the housing in a plan view of the open side.

The provision of lugs which reduce the size of the open cross section of the antenna housing allows a major increase in the bandwidth to be achieved while, in contrast, the prior art would have to increase the size of the open cross section of the antenna housing.

Further advantageous embodiments are characterized in the dependent claims.

One exemplary embodiment of an antenna according to the invention will be described in more detail in the following text with reference to the drawings, in which:

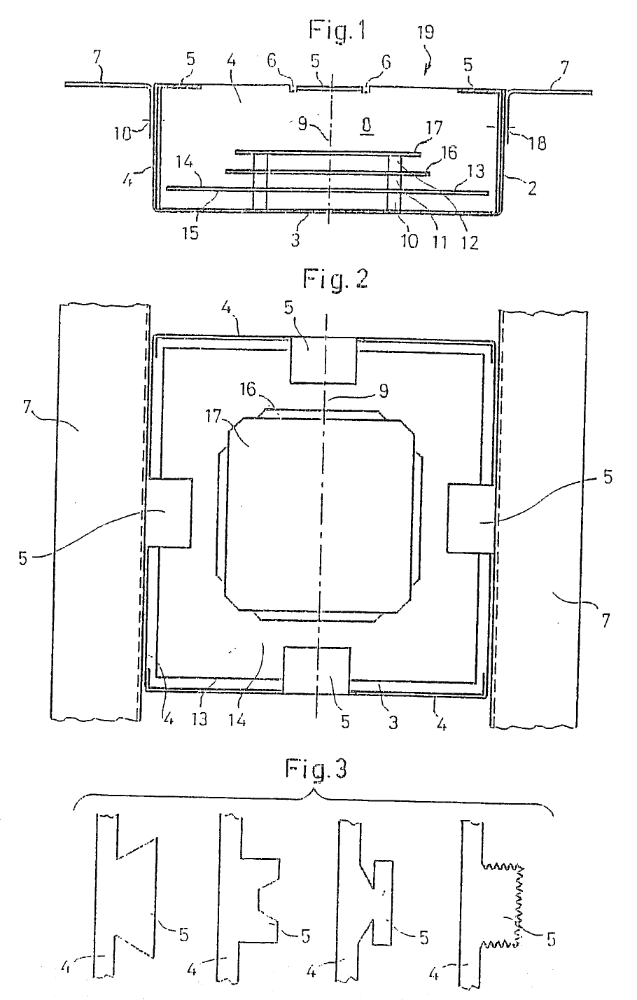

FIG. 1 shows a cross-sectional view through an antenna according to the invention,

FIG. 2 shows a plan view of the antenna shown in FIG. 1, and

FIG. 3 shows further lug shapes for the antenna as shown in FIG. 1.

FIG. 1 shows the cross-sectional view of an antenna 1 which is arranged in a housing 2. The housing 2 comprises a bottom 3 and four side walls 4. The housing is essentially open in the direction pointing upward in the plane of the drawing. Here, the housing 2 has four lugs 5 which are each arranged in the center of the sides and project parallel to the housing bottom 3 into the interior of the housing 2. The lugs 5 are described in more detail in FIG. 2. It can be seen from FIG. 1 that, in addition to the lugs 5, there are small rectangular grooves 6 in the side wall, so that the lugs 5 merge with a transition at the same level into the upper edge of the side walls 4.

The housing 2 is introduced between two L-shaped brackets 7 on two opposite side walls 4. The brackets 7 are connected to the housing wall via a nut and bolt connection at the point annotated by the reference symbol 18. Instead of this detachable connection, whose advantage will be explained further below, it is alternatively possible to provide an adhesive bond or some other firm connection. The housing is designed to be conductive, in the same way as the lugs 5 which are integrally connected to it. In another embodiment, the lugs 5 may also, for example, be mounted on the housing walls 4 via a bracket, in which case there must be a conductive connection between the housing walls 4 and the lugs 5.

The housing 2 forms a cavity 8 which is filled with ambient air and which, in the illustrated case, is designed to be symmetrical with respect to the center plane 9. The housing 2 is essentially open at the top except for the lugs 5, of which there are four here, in each case arranged at the center of the side surfaces and projecting into the interior of the housing 2.

These four lugs 5, which are right-angled here, reduce the cross-sectional size symmetrically, in a plan view.

Four mounts are in this case provided on the housing bottom 3, with three segments 10, 11 and 12, which act as spacers between the housing bottom 3, the baseplate 13 (on which the conductive layer 14 which has at least one coupling opening and a stripline network 15 are located) and two patch plates 16 and 17. The stripline network 15 may in this case be arranged opposite the patch 16 or opposite the housing bottom 3.

The area between the baseplate 13 and the patches 16, 17 which are arranged above it is filled with ambient air (permittivity 1.0), which in contrast to the prior art from the Ecole Polytechnique Fédérale de Lausanne, uses a substrate material with a permittivity of 2.33. The ground plane which is formed by the baseplate 13 is connected, in a non-conductive manner, to the housing 2. The arrangement of the lugs 5 in the interior of the housing 2 considerably increases the relative bandwidth of the antenna. The arrangement as illustrated in FIG. 1 allows a relative bandwidth of more than 35% to be achieved for a VSWR of two (10 dB matching). The physical height of the arrangement as shown in FIG. 1 is 36 millimeters, in contrast to 70 millimeters for the prior art, for the stated frequency band for UTMS and GSM 1800.

The horizontal 3 dB beamwidth for a vertically polarized antenna can be adjusted via the width and position of the brackets 7. If the brackets are arranged as shown in FIG. 1, the 3 dB beamwidth is 65°. If the brackets 7 are moved downward, so that they end flush with the housing bottom 3, the 3 dB beamwidth is approximately 90°. Since these are the two main 3 dB beamwidths which are used for mobile radio, a mechanical apparatus with a vertically running slot at the point 18 can be used to make it possible to move the brackets 7 in a continuously variable manner vertically thus resulting in an antenna with the 3 dB beamwidth of 65° to 90°, depending on the application. In this case, the brackets 7 need not be electrically conductively connected to the housing. One advantageous embodiment in this case is a nut and bolt connection, but any other mechanical solution which allows the height of the brackets to be adjusted is also suitable.

The brackets 7 may be longer than the associated housing sides 4 of the housing 2, as is indicated in FIG. 2, in particular being twice as long. The baseplate 13 with the conductive surface 14 essentially completely covers the housing bottom 3 of the housing in a plan view, but with there being no conductive contact between the two elements, each of which is individually conductive.

The lugs 5 are in this case designed to be parallel to the housing bottom 3, and rectangular. However, they may also have other shapes, which are illustrated in a number of embodiments in FIG. 3. For example, square or trapezoidal shapes are possible, in which case the two mutually opposite lugs 5 are preferably each designed to be the same. Four different shapes may also be chosen provided, in particular, that the respective surfaces of the lugs 5 always remain constant on each side. The lugs 5 may also be designed with curved edges, which merge continuously into one another. The lugs 5 may also be positioned at an angle to the housing bottom 3, thus projecting into the housing 2 or beyond the edges of the side walls 4. Their size is, for example, 10% of the size of a patch 16 or 17, but may also be chosen to be between 5 and 25%. The lugs 5 cover the open side 19 of the housing 2 only to the extent that they do not cover the patches 16, 17 in a plan view of the open side of the housing 2. The lugs 5 may also be recessed to the level of the upper patch 17.

In this case the housing 2 is square, but a rectangular shape is likewise possible, although the ratio of the sides should not be greater than 2:1. The patch 17 is essentially of the same size, and in this case occupies 33% of the housing cross-sectional area. The patch 16 is somewhat larger than the patch 17, but the patch 16 has corners which are cut off at the sides, so that this side edge runs under the patch 17. Other variants can likewise be used and, in particular, the patch 17 may also be larger than the patch 16.

Materials with a higher permittivity may also be used between the individual plates 14 and the patches 16, 17, for example, RF-compatible material with a permittivity of up to 10. The spaces between said elements 14, 16 and 17 may also be partially filled with a dielectric.

Patent claims

1. A broadband communications antenna having a baseplate (13) which has a conductive layer (14) having at least one coupling opening, with a stripline network (15) being provided at a short distance from the conductive layer (14) in the region of the coupling openings, with at least one conductive patch (16, 17) being arranged opposite the baseplate (13), with the baseplate (13) and the patch (16, 17) being arranged in a conductive housing (2) which has one open side (19), and with the baseplate being arranged closest to the housing bottom (3) and thus furthest away from the open side (19), characterized in that one or more lugs (5) are provided on the open side (19) of the housing (2) and reduce the size of the open cross-sectional area of the housing (2) in a plan view of the open side (19).

2. The broadband communications antenna as claimed in claim 1, characterized in that the housing (2) is rectangular, and in that a lug (5) is arranged centrally on the side surface on each of the four sides (4).

3. The broadband communications antenna as claimed in claim 1 or claim 2, characterized in that, if there are a number of lugs (5), the area of each lug is equal to the area of every other lug (5).

4. The broadband communications antenna as claimed in one of claims 1 to 3, characterized in that the lug or lugs (5) is or are rectangular and runs or run parallel to the housing bottom (3).

5. The broadband communications antenna as claimed in one of claims 1 to 4, characterized in that the size of each of the lugs (5) does not exceed 10 percent of the size of a patch (16, 17).

6. The broadband communications antenna as claimed in one of claims 1 to 5, characterized in that the lugs (5) cover the open side (19) of the housing (2) only to such an extent that they do not cover a patch (16, 17) in a plan view of the open side (19).

7. The broadband communications antenna as claimed in one of claims 1 to 6, characterized in that a material whose permittivity is essentially equal to 1.0 is located between the baseplate (13), on which the conductive layer (14) and the stripline network (15) are located, and the patch or patches (16, 17).

8. The broadband communications antenna as claimed in one of claims 1 to 7, characterized in that the conductive layer (14) which is located on the baseplate (13) virtually completely covers the housing bottom (3), without being conductively connected to the side walls (4) of the housing (2).

9. The broadband communications antenna as claimed in one of claims 1 to 8, characterized in that side angled surfaces (7) are provided on two opposite sides of the housing (2), and form a surface which runs parallel to the housing bottom (3).

10. The broadband communications antenna as claimed in claim 9, characterized in that at least one elongated hole (8) is provided in each of the two opposite sides of the housing (2), through which the side angled surfaces (7) can be adjusted in height with respect to the housing bottom (3) by means of a nut and bolt connection.
